(19) United States
(12) Patent Application Publication
(10) Pub. No.: US 2025/0088705 A1
(43) Pub. Date: Mar. 13, 2025

(54) SYSTEMS AND METHODS FOR PROVIDING RAPID CONTENT SWITCHING IN MEDIA ASSETS FEATURING MULTIPLE CONTENT STREAMS THAT ARE DELIVERED OVER COMPUTER NETWORKS

(71) Applicant: Orb Reality LLC, Washington, DC (US)

(72) Inventors: Roy Feinson, Washington, DC (US); Basem Salloum, Washington, DC (US)

(73) Assignee: Orb Reality LLC, Washington, DC (US)

(21) Appl. No.: 18/708,195

(22) PCT Filed: Nov. 3, 2022
(86) PCT No.: PCT/US2022/079219

§ 371 Date: May 7, 2024

Related U.S. Application Data
(60) Provisional application No. 63/276,971, filed on Nov. 8, 2021.

(51) Int. Cl. H04N 21/438; H04N 21/218; H04N 21/2365

(52) U.S. Cl. CPC H04N 21/4384; H04N 21/21805; H04N 21/2365

(57) ABSTRACT

Methods and systems are described herein for interacting with and enabling access to novel types of content through the rapid content switching in media assets featuring multiple content streams. For example, in media assets featuring multiple content streams, each content stream may represent an independent view of a scene in a media asset. During playback of the media asset, a user may only view content from only one of the multiple content streams. The user may then switch between the different content streams to view different angles, instances, versions, etc. of the scene.

### CROSS-REFERENCE TO RELATED APPLICATION(S)

This application claims the benefit of priority of U.S. Provisional Application No. 63/276,971, filed Nov. 8, 2021. The content of the foregoing application is incorporated herein in its entirety by reference.

### BACKGROUND

In recent years, users are now accessing content on numerous devices and in numerous platforms. Moreover, the ways in which users interact with and access (e.g., through mobile devices, gaming platforms, and virtual reality devices) content is ever changing, as well as the content itself (e.g., from high-definition content to 3D content and beyond). Accordingly, users are always looking for new types of content and new ways of interacting with that content.

### SUMMARY

Methods and systems are described herein for interacting with and enabling access to novel types of content through the rapid content switching in media assets featuring multiple content streams. For example, in media assets featuring multiple content streams, each content stream may represent an independent view of a scene in a media asset. During playback of the media asset, a user may only view content from one of the multiple content streams. The user may then switch between the different content streams to view different angles, instances, versions, etc. of the scene. For example, users may change the viewing angle of a scene displayed on a screen using a control device. By moving the control device in a particular direction, the viewing angle of the scene displayed on the screen may be changed in a corresponding direction, allowing the user to view the scene from different angles.

To generate the media assets, the system may use multiple content capture devices (e.g., cameras, microphones, etc.). To allow for substantially visually smooth transitions upon transition between content streams, the system may use content capture devices that are positioned sufficiently close to each other. Accordingly, in response to a user request to change a content stream (e.g., a viewing angle, instance, version, etc.) to a new content stream (e.g., via a user input indicating a change along a vertical and horizontal axis, or in any of six degrees of freedom using a control device, such as a joystick, mouse or screen swipe, etc.), the system may select a content stream that allows for the presentation of the media asset to appear to have a smooth transition from one content stream to the next.

Accordingly, the media asset presents a seamless change from a first content stream (e.g., a scene from one angle) to a second content stream (e.g., a scene from a second angle) such that from the perspective of the viewing user, it appears as if the user is walking around the scene. To achieve such a technical feat, the system synchronizes each of the multiple content stream during playback. For example, when individual content streams (e.g., videos) are filmed by the content capture devices in close enough proximity (e.g., in any number of spatial arrangements such as a circle), the system may achieve a “bullet-time” effect where a single content stream appears to smoothly rotate around an object, and this effect may be achieved under user control. As such, the resulting playback creates an illusion of a smooth sweep of the camera around the scene, allowing the user to view the action from any angle, including above and below the actors, or anywhere content capture devices have been placed. During user-controlled playback, each independent content stream may be viewed separately in real-time based on a user's selection of the independent content stream.

However, to provide a media asset that allows for such rapid succession creates numerous technical hurdles. For example, effectuating switching between videos under user control using a conventional approach and/or conventional video streaming protocol would comprise: (i) accepting a user-initiated signal to the server or other video playback system to switch videos; (ii) in response to the signal, storing the frame number (N) of the current frame in memory; (iii) opening the next video in the sequence; (iv) accessing frame N+1 in the new video, and closing the previous video stream; (v) beginning streaming of the video to the user's device; and (vi) launching the new video at frame N+1. Due to the number of steps and the inherent need to transfer information back and forth, the system does not locate, load, and generate the new video quickly enough to provide a seamless transition. For example, when used with current software protocols—whether in browser-based or standalone video players-it is not possible to open and close multiple videos at a rate that achieves flicker fusion (approximately 20-30 videos per second). Even if the server or connection to the hard drive is extremely rapid, delays in the open/close/jump-to-frame sequence causes frame dropping and loss of synchronization, creating unwanted video effects.

To overcome these technical hurdles, and to enable the smooth transition between content streams (e.g., achieve flicker fusion) and to maintain the synchronization, the system may transfer multiple content streams in parallel and generate (albeit without display) multiple content streams simultaneously. Unfortunately, this approach is also not without its technical challenges. For example, transferring and/or generating multiple content streams simultaneously may create bottlenecks inherent in transmission speeds, whether using internet protocols, WI-FI, or served from a local drive. For example, while conventional streaming video technology is designed to deliver flicker-free video via cable, Wi-Fi, or locally stored files, it is not possible to rapidly and smoothly switch between a number of independent videos in a streaming or local environment.

Accordingly, in order to overcome these technical challenges, the system creates a combined content stream based on a plurality of content streams for a media asset, wherein each of the plurality of content streams corresponds to a respective view of the media asset. In particular, each from of the combined content stream has portions dedicated to one of the plurality of content streams. The system then selects which of the content streams (e.g., which portion of the frame of the combined stream) to generate for display based on the respective views corresponding to each of the plurality of content streams. While one view (e.g., portion of the frame of the combined stream), the other views are hidden from view. For example, the system may scale the selected view (e.g., from 1920×1080 pixels corresponding to a portion of the frame of the combined stream to a 3840×2160 pixel version) to fit the contours of a user interface in which the media asset is displayed. When a new view is selected, the system simply scales the corresponding portion of the frame of the combined stream. As there is no need to fetch a new stream (e.g., from a remote source), load, and process the new stream, the system may seamlessly transition (e.g., achieve flicker fusion) between the views.

In some aspects, methods and systems are described for providing rapid content switching in media assets featuring multiple content streams that are delivered over computer networks. For example, the system may receive a first combined content stream based on a first combined frame, and a second combined frame, wherein the first combined frame is based on a first frame set, wherein the first frame set comprises a first frame from each of a first plurality of content streams that corresponds to a first time mark in each of the first plurality of content streams; the second combined frame is based on a second frame set, wherein the second frame set comprises a second frame from each of the first plurality of content streams that corresponds to a second time mark in each of the first plurality of content streams; and the first plurality of content streams is for a media asset, wherein each content stream of the first plurality of content streams corresponds to a respective view of a scene in the media asset. The system may then process for display, in a first user interface of a user device, the first combined content stream.

Various other aspects, features, and advantages of the invention will be apparent through the detailed description of the invention and the drawings attached hereto. It is also to be understood that both the foregoing general description, and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative user interface for presenting a media asset through rapid content switching between multiple content streams, in accordance with one or more embodiments.

FIG. 2 shows an illustrative system for generating media assets featuring multiple content streams, in accordance with one or more embodiments.

FIG. 3 is another illustrative system for generating media assets featuring multiple content streams, in accordance with one or more embodiments.

FIG. 4 is an illustrative system architecture for providing rapid content switching in media assets featuring multiple content streams that are delivered over computer networks, in accordance with one or more embodiments.

FIG. 5 is an illustrative example of a combined frame based on a plurality of content streams, in accordance with one or more embodiments.

FIG. 6 is an illustrative example of a concatenated combined frame based on a plurality of content streams, in accordance with one or more embodiments.

FIG. 7 is an illustrative example of a pair of concatenated combined frames based on a plurality of content streams, in accordance with one or more embodiments.

FIG. 8 is an illustrative example of selecting an area of a frame for zooming upon, in accordance with one or more embodiments.

FIGS. 9A-B are an illustrative examples of determining a series of views to transition through when switching between views, in accordance with one or more embodiments.

FIG. 10 is an illustrative example of a playlist of a series of views, in accordance with one or more embodiments.

FIG. 11 shows a flowchart of the steps involved in providing rapid content switching in media assets featuring multiple content streams that are delivered over computer networks, in accordance with one or more embodiments.

FIG. 12 shows a flowchart of the steps involved in generating media assets featuring multiple content streams, in accordance with one or more embodiments.

FIG. 13 is an illustrative system for generating media assets featuring multiple content streams in large areas, in accordance with one or more embodiments.

FIG. 14 shows an illustrative content capture device for generating media assets featuring multiple content streams, in accordance with one or more embodiments.

FIG. 15 is an illustrative system for generating media assets featuring multiple content streams in large areas featuring a pre-selected section with a desired field of view, in accordance with one or more embodiments.

FIG. 16 shows an illustrative diagram related to calculating zoom, in accordance with one or more embodiments.

FIG. 17 shows an illustrative diagram related to calculating tilt, in accordance with one or more embodiments.

FIG. 18 shows an illustrative diagram related to post-production of media assets featuring multiple content streams, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details, or with an equivalent arrangement. In other cases, well-known structures and devices are shown in block diagram form in order to avoid unnecessarily obscuring the embodiments of the invention.

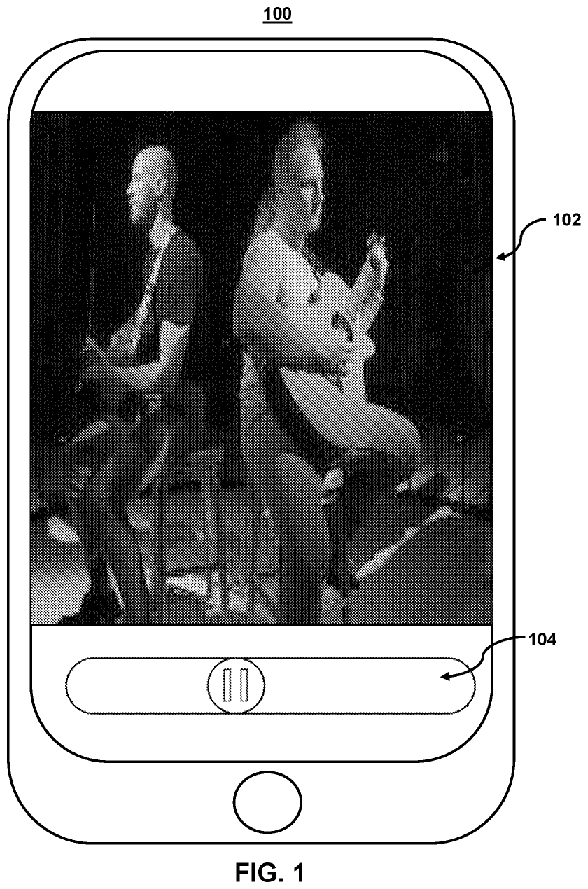

FIG. 1 shows an illustrative user interface for presenting a media asset through rapid content switching between multiple content streams, in accordance with one or more embodiments. For example, rapid content switching causes a media asset to be presented in a seamless manner as it changes from a first content stream (e.g., a scene from one angle as captured by a first camera) to a second content stream (e.g., a scene from a second angle as captured from a second camera) such that from the perspective of the viewing user, it appears as if the user is walking around the scene. It should be noted that as described throughout this disclosure a reference to a viewing angle (e.g., as described when switching from one viewing angle to another) may also reference switching from one camera to another.

For example, FIG. 1 may include user device 100, which is currently displaying content in user interface 102. For example, user interface 102 may comprise content received for display in a user interface of a web browser on a user device (e.g., user device 100) to a user. As referred to herein, a “user interface” may comprise a human-computer interaction and communication in a device, and may include display screens, keyboards, a mouse, and the appearance of a desktop. For example, a user interface may comprise a way in which a user interacts with an application or website. As referred to herein, “content” should be understood to mean an electronically consumable media asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactive content forms. Content may be recorded, played, displayed, or accessed by user devices, but can also be part of a live performance. The content of a media asset may be represented in a “content stream,” which may be content that has a temporal element associated with it (e.g., allowing playback). A content stream may correspond to a stream (e.g., a series of frames played back in series) to form a media asset (e.g., a video).

In some embodiments, the content may be personalized for a user based on the original content and user preferences (e.g., as stored in a user profile). A user profile may be a directory of stored user settings, preferences, and information for the related user account. For example, a user profile may have the settings for the user's installed programs and operating system. In some embodiments, the user profile may be a visual display of personal data associated with a specific user, or a customized desktop environment. In some embodiments, the user profile may be a digital representation of a person's identity. The data in the user profile may be generated based on the system actively or passively monitoring the user's actions.

User interface 102 is currently displaying content that is being played back. For example, a user may adjust playback of the content using track bar 104 to perform a playback operation (e.g., a play, pause, or other operation). For example, an operation may pertain to playing back a non-linear media asset at faster than normal playback speed, or in a different order than the media asset is designed to be played, such as a fast-forward, rewind, skip, chapter selection, segment selection, skip segment, jump segment, next segment, previous segment, skip advertisement or commercial, next chapter, previous chapter, or any other operation that does not play back the media asset at normal playback speed. The operation may be any playback operation that is not “play,” where the play operation plays back the media asset at normal playback speed.

In addition to normal playback operations, the system may allow a user to switch between different views of the media asset (e.g., media assets based on multiple content streams). For example, in media assets featuring multiple content streams, each content streams may represent an independent view of a scene in a media asset. During playback of the media asset, a user may only view content from one of the multiple content streams. The user may then switch between the different content streams to view different angles, instances, versions, etc. of the scene. For example, users may change the viewing angle of a scene displayed on a screen using a control device. By moving the control device in a particular direction, the viewing angle of the scene displayed on the screen may be changed in a corresponding direction allowing the user to view the scene from different angles.

For example, the system may change the viewing angle displayed on screen in response to user inputs into a control device (e.g., in a particular direction), which causes the viewing angle/direction of the content to be changed in a corresponding direction. As such, the system appears to the user as if the user is moving around and viewing a scene from a different angle. For example, a leftward movement of a joystick handle may cause a clockwise rotation of the image, or rotation about another axis of rotation with respect to the screen. Users may be able to scroll in one direction of viewing to the other by pressing a single button or multiple buttons, each of which is associated with a predetermined angle of viewing, etc. Additionally or alternatively, a user may select to follow a playlist of viewing angles.

Furthermore, the system may achieve these changes while achieving flicker fusion. Flicker fusion relates to a frequency at which an intermittent light stimulus appears to be completely steady to the average human observer. A flicker fusion threshold is therefore related to persistence of vision. Although flicker can be detected for many waveforms representing time-variant fluctuations of intensity, it is conventionally, and most easily, studied in terms of sinusoidal modulation of intensity. There are seven parameters that determine the ability to detect the flicker, such as the frequency of the modulation, the amplitude or depth of the modulation (i.e., what is the maximum percent decrease in the illumination intensity from its peak value), the average (or maximum—these can be inter-converted if modulation depth is known) illumination intensity, the wavelength (or wavelength range) of the illumination (this parameter and the illumination intensity can be combined into a single parameter for humans or other animals for which the sensitivities of rods and cones are known as a function of wavelength using the luminous flux function), the position on the retina at which the stimulation occurs (due to the different distribution of photoreceptor types at different positions), the degree of light or dark adaptation, i.e., the duration and intensity of previous exposure to background light, which affects both the intensity sensitivity and the time resolution of vision, and/or physiological factors, such as age and fatigue. As described herein, the system can achieve flicker fusion according to one or more of these parameters.

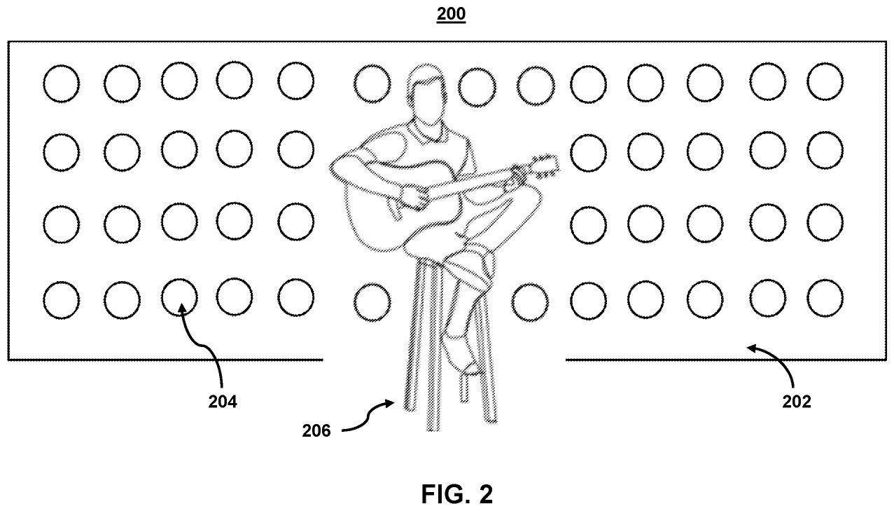

FIG. 2 shows an illustrative system generating media assets featuring multiple content streams, in accordance with one or more embodiments. For example, FIG. 2 shows an example of a surround filming mounting matrix configured to film a scene. In various embodiments, a surround video recording arrangement 200 includes content capture device mounting matrix 202, which is used to support and position many content capture devices 204. This can be on the order of 10's, 100's, or more content capture devices to record a scene 206. In another embodiment, the many content capture devices 204 are stand-alone content capture devices and are not mounted on a mounting matrix.

In various embodiments, user-controlled playback of a multi-stream video is enabled by recording arrangement 200, where scene 206 is recorded simultaneously using multiple content capture devices to generate a multi-stream video, each content capture device recording the same scene from a different direction. In some embodiments, the content capture devices may be synchronized to start recording the scene at the same time, while in other embodiments, the recorded scene may be post-synchronized on a frame number and/or time basis. In yet another embodiment, at least two of the content capture devices may record the scenes consecutively. Each content capture device generates an independent content stream of the same scene, but from a different direction compared with other content capture devices, depending on the content capture device's position in mounting matrix 202, or, in general, with respect to other content capture devices. The content streams obtained independently may be tagged for identification and/or integrated into one multi-stream video allowing dynamic user selection of each of the content streams during playback for viewing.

In some recording embodiments, multiple content capture devices are positioned sufficiently close to each other to allow for substantially visually smooth transition between content capture device content streams at viewing time, whether real-time or prerecorded, when the viewer/user selects a different viewing angle. For example, during playback, when a user moves a viewing angle of a scene using a control device, such as a joystick, from left to right of the scene, the content stream smoothly changes, showing the scene from the appropriate angle, as if the user himself is walking around the scene and looking at the scene from different angles. In other recording embodiments, the content capture devices may not be close to each other, and the viewer/user can drastically change its viewing direction. In yet other embodiments, the same scene may be recorded more than one time, from different coordinates and/or angles, in front of the same content capture device to appear as if more than one content capture device had captured the original scene from different directions. In such arrangements, to enhance the impact of that particular scene on the user, each act may be somewhat different from the similar acts performed at other angles. Such recordings may later be synchronized and presented to the viewer/user to create the illusion of watching the same scene from multiple angles/directions.

During user-controlled playback, each independent content stream may be viewed separately in real-time or may be recorded for later viewing based on a user's selection of the independent content stream. In general, during playback, the user will not be aware of the fact that the independent content streams may not have been recorded simultaneously. In various embodiments, the independent content streams may be electronically mixed together to form a single composite signal for transmission and/or storage, from which a user-selected content stream may be separated by electronic techniques, such as frequency filtering and other similar signal processing methods. Such signal processing techniques include both digital and analog techniques, depending on the type of signal.

In various embodiments, multiple content streams may be combined into a multi-stream video, each stream of which is selectable and separable from the multi-stream video at playback time. The multi-stream video may be packaged as a single video file, or as multiple files usable together as one subject video. An end user may purchase a physical medium (e.g., a disk) including the multi-stream video for viewing with variable angles under the user's control. Alternatively, the user may download, stream, or otherwise obtain and view the multi-stream video with different viewing angles and directions under his control. The user may be able to download or stream only the direction-/angle-recordings he/she wants to view later on.

In various embodiments, after filming is complete, the videos from each camera or content capture device may be transferred to a computer hard drive or other similar storage device. In some embodiments, content capture devices acquire an analog content stream, while in other embodiments, content capture devices acquire a digital content stream. Analog content streams may be digitized prior to storage on digital storage devices, such as computer hard disks. In some embodiments, each content stream or video may be labeled or tagged with a number or similar identifier corresponding to the content capture device from which the content stream was obtained in the mounting matrix. Such identifier may generally be mapped to a viewing angle/direction usable by a user during viewing.

In various embodiments, the content stream identifier is assigned by the content capture device itself. In other embodiments, the identifier is assigned by a central controller of multiple content capture devices. In still other embodiments, the content streams may be independently recorded by each content capture device, such as a complete video camera, on a separate medium, such as a tape, and be tagged later manually or automatically during integration of all content streams into a single multi-stream video.

In various embodiments, mounting matrix 202 may be one, two, or three dimensional, such as a curved, spherical, or flat mounting system providing a framework for housing a matrix of content capture devices mounted to the outside (scene facing side) of the mounting matrix with lenses pointing inward to the center of the curved matrix. A coverage of 360° around a scene may be provided by encasing the scene in a spherical mounting matrix completely covered with cameras. For large scenes, some or all content capture devices may be individually placed at desired locations around the scenes, as further described below. In some embodiments, the mounting matrix and some of the individual content capture devices are dynamically movable, for example, by being assembled on a wheeled platform, to follow a scene during active filming.

Similarly to camera lenses discussed above, in the case of a spherical or near spherical mounting matrix used to encase the subject scene during filming, lighting may be supplied through a series of small holes in the mounting matrix. Because of their regularity of placement, shape, and luminosity, these lights may also be easily recognized and removed in post-production.

In various embodiments, recording arrangement 200 includes mounting matrix 202, which is used to position and hold content capture devices substantially focused on scene 206, in which different content capture devices are configured to provide 3-D, and more intense or enhanced 3-D effects, respectively.

One function of mounting matrix 202 is to provide a housing structure for the cameras or other recording devices, which are mounted in a predetermined or regular pattern, close enough together to facilitate smooth transitioning between content streams during playback. The shape of the mounting matrix modifies the user experience during playback. The ability to transform the shape of the mounting matrix based on the scene to be filmed allows for different recording angles/directions, and thus, different playback experiences.

In various embodiments, mounting matrix 202 is structurally rigid enough to reliably and stably support numerous content capture devices, yet flexible enough to curve around the subject scene to provide a surround effect with different viewing angles of the same subject scene. In various embodiments, mounting matrix 202 may be a substantially rectangular plain, which may flex in two different dimensions of its plane, for example, horizontally and vertically, to surround the subject scene from side to side (horizontal), or from top to bottom (vertical). In other various embodiments, mounting matrix 202 may be a plane configurable to take various planar shapes, such as spherical, semi-spherical, or other 3D planar shapes. The different shapes of the mounting matrix enable different recording angles and thus different playback perspectives and angles.

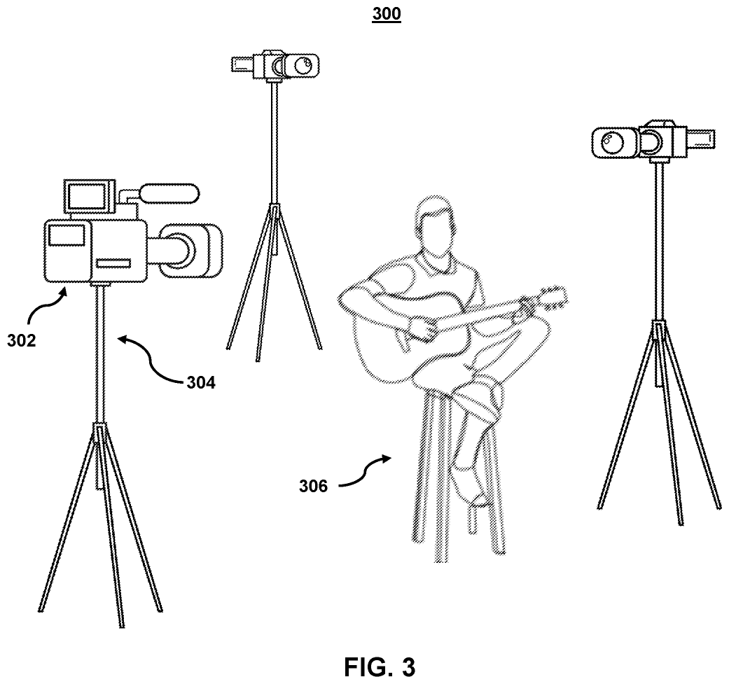

In various embodiments, selected pairs of content capture devices, and the corresponding image data streams may provide various degrees of 3D visual effects. For example, a first content capture devices pair may provide image data streams, which when viewed simultaneously during playback create a 3D visual effect with a corresponding perspective depth. A second content capture device pair may provide image data streams which, when viewed simultaneously during playback, create a different 3D visual effect with a different and/or deeper corresponding perspective depth, compared to the first camera pair, thus, enhancing and heightening the stereoscopic effect of the camera pair. Other visual effects may be created using selected camera pairs, which are not on the same horizontal plane, but separated along a path in 2D or 3D space on the mounting matrix. In other various embodiments, mounting matrix 202 is not used. These embodiments are further described below with respect to FIG. 3.

In some embodiments, at least one or all content capture devices are standalone, independent cameras, while in other embodiments, each content capture device is an image sensor in a network arrangement coupled to a central recording facility. In still other embodiments, a content capture device is a lens for collecting light and transmitting to one or more image sensors via an optical network, such as a fiber optic network. In still other embodiments, content capture devices may be a combination of one or more of the above.

In various embodiments, the content streams generated by the content capture devices are pre-synchronized prior to the commencement of recording a scene. Such pre-synchronization may be performed by starting the recording by all the content capture devices simultaneously, for example, by a single remote control device sending a broadcast signal to all content capture devices. In other embodiments, the content capture devices may be coupled to each other to continuously synchronize the start of recording and their respective frame rates while operating. Such continuous synchronization between content capture devices may be performed by using various techniques, such as using a broadcast running clock signal, using a digital message passing bus, and the like, depending on the complexity and functionality of the content capture devices.

In other embodiments, at least some of the content streams generated by the content capture devices are post-synchronized after the recording of the scene. The object of synchronization is to match up the corresponding frames in multiple content streams, which are recorded from the same scene from different angles, but at substantially the same time. Post-synchronization may be done using various techniques, such as time-based techniques, frame-based techniques, content matching, and the like.

In various embodiments, in time-based techniques, a global timestamp is used on each content stream, and the corresponding frames are matched together based on their respective timestamps. In frame-based techniques, a frame count from a starting common frame position on all content streams is used to match up subsequent frames in the content stream. For example, the starting common frame may include an initial one or few frames of a special scene recorded for this purpose, such as a striped pattern. In content-matching techniques, elements of image frame contents may be used to match up corresponding frames. Those skilled in the art will appreciate that other methods for post-synchronization may be used without departing from the spirit of the present disclosures.

In various embodiments, the surround video recording arrangement may be completely integrated with current 3D recording and/or viewing technology by employing an offset between content capture devices recording the same scene, which are positioned at a predetermined distance apart from each other. Because content streams from different content capture devices are user selectable during viewing, an enhanced or exaggerated 3D effect may be affected by selecting content streams from content capture devices which were farther away from each other during recording than cameras used in a normal 3D stereo recording set slightly apart, usually about the distance between human eyes. This dynamic selectability of content streams provides a variable 3D feature while viewing a scene. Recently, 3D video and movies have been rapidly becoming ubiquitous, and a “4-D” surround video, where a 3D image may also be viewed from different angles dynamically, further enhances this trend.

While, generally, it may not be necessary to employ multiple sound tracks in a surround video recording system, and a single master sound track may generally suffice, if each content capture device or camera on the mounting matrix included an attached or built-in microphone, and the soundtracks for each content stream were switched with the corresponding content stream, a surround-sound effect, which in effect moves the sound along with the camera view, may be achieved through a single playback speaker, in contrast to traditional surround sound systems, which need multiple speakers. For example, in a conversation scene, as content streams are selected from corresponding camera positions which were closer to a particular actor during filming, the actor's voice would be heard louder than a content stream corresponding to a camera farther away from the actor.

For example, while providing rapid content switching in media assets featuring multiple content streams that are delivered over computer networks, the system may determine particular audio tracks (e.g., from respective content capture devices) that correspond to a combined content stream. For example, the combined content stream may be based on a first combined frame and a second combined frame, wherein the first combined frame is based on a first frame set, wherein the first frame set comprises a first frame from each of a first plurality of content streams that corresponds to a first time mark in each of the first plurality of content streams. Additionally, the second combined frame may be based on a second frame set, wherein the second frame set comprises a second frame from each of the first plurality of content streams that corresponds to a second time mark in each of the first plurality of content streams.

As the system selects the frames for inclusion in the combined content stream, the system may likewise retrieve audio samples that correspond to the frames from the respective content capture devices. For example, the system may determine a combined audio track to present with the first combined content stream. In such cases, the combined audio track may comprise a first audio track corresponding to the first combined frame and a second audio track corresponding the second combined frame. Furthermore, the first audio track may be captured with a content capture device that captured the first frame set, and the second audio track may be captured with a content capture device that captured the second frame set.

Those skilled in the art will appreciate that the surround video system may be applied to still images instead of full motion videos. Using still cameras in the mounting matrix, a user may “move around” objects photographed by the system by changing the photographed viewing angle.

In various embodiments, the surround video system may be used to address video pirating problems. A problem confronted by media producers is that content may be very easily recorded by a viewer/user and disseminated across the Internet. Multiple content streams provided by the surround video system may be extremely difficult to pirate, and still provide the entire interactive viewing experience. While it would be possible for a pirate to record and disseminate a single viewing stream, there is no simple way to access the entire set of camera angles that make up the surround video experience.

FIG. 3 is another illustrative system for generating media assets featuring multiple content streams, in accordance with one or more embodiments. For example, FIG. 3 shows an example surround filming apparatus with independently positioned cameras configured to film a scene. In some embodiments, instead of using one integrated mounting matrix, independently positioned content capture devices 302, such as video cameras, are deployed on independent supports 304, such as tripods, to record a scene 306. In such embodiments, which may be employed in filming large areas, such as outdoor scenes, content capture devices may be positioned at arbitrary points around the subject scene for recording a film substantially simultaneously or consecutively. Synchronization may be performed post image acquisition on different content streams so obtained. Simultaneous synchronization by wired or wireless methods is also possible in the case of separately located content capture devices. The various content capture device positions may be specified with respect to each other using various techniques, such as GPS, 3D grid-based specification, metes and bounds, and the like. Generally, knowing the physical location and the direction of the line of sight of a content capture device allows the determination of the angle or direction of viewing of the subject scene.

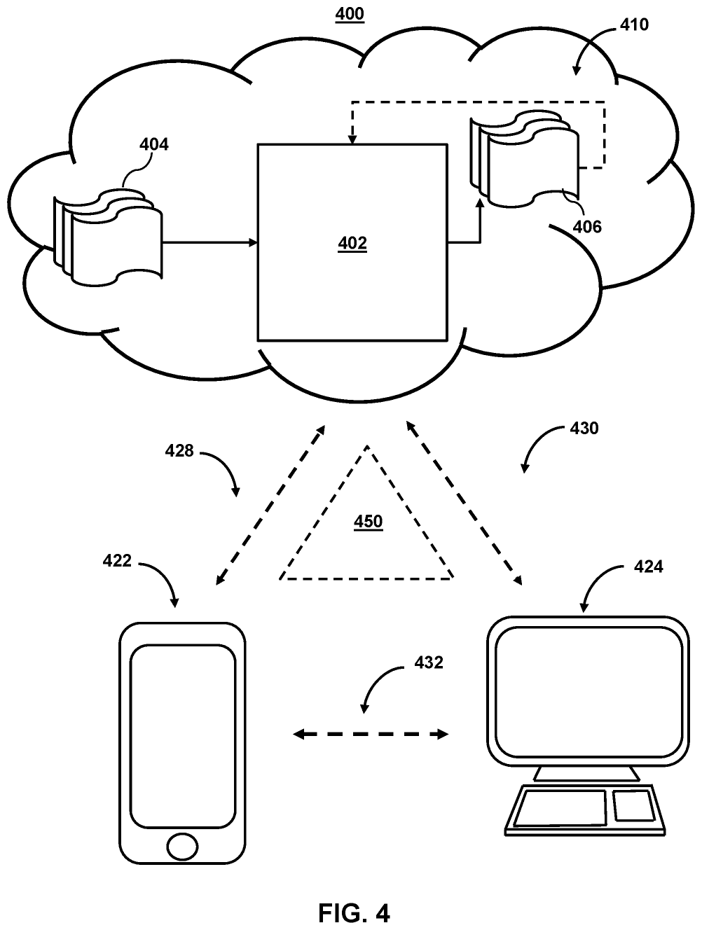

FIG. 4 is an illustrative system architecture for providing rapid content switching in media assets featuring multiple content streams that are delivered over computer networks, in accordance with one or more embodiments. For example, system 400 may represent the components used for providing rapid content switching in media assets featuring multiple content streams, as shown in FIG. 1. As shown in FIG. 4, system 400 may include mobile device 422 and user terminal 424. While shown as a smartphone and personal computer, respectively, in FIG. 4, it should be noted that mobile device 422 and user terminal 424 may be any computing device, including, but not limited to, a laptop computer, a tablet computer, a hand-held computer, other computer equipment (e.g., a server), including “smart,” wireless, wearable, and/or mobile devices.

FIG. 4 also includes cloud components 410. Cloud components 410 may alternatively be any computing device as described above, and may include any type of mobile terminal, fixed terminal, or other device. For example, cloud components 410 may be implemented as a cloud computing system and may feature one or more component devices. It should also be noted that system 400 is not limited to three devices. Users, may, for instance, utilize one or more devices to interact with one another, one or more servers, or other components of system 400. It should be noted, that, while one or more operations are described herein as being performed by particular components of system 400, those operations may, in some embodiments, be performed by other components of system 400. As an example, while one or more operations are described herein as being performed by components of mobile device 422, those operations may, in some embodiments, be performed by one or more of cloud components 410. In some embodiments, the various computers and systems described herein may include one or more computing devices that are programmed to perform the described functions. Additionally, or alternatively, multiple users may interact with system 400 and/or one or more components of system 400. For example, in one embodiment, a first user and a second user may interact with system 400 using two different components.

With respect to the components of mobile device 422, user terminal 424, and cloud components 410, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 4, both mobile device 422 and user terminal 424 include a display upon which to display data (e.g., conversational response, queries, and/or notifications).

Additionally, as mobile device 422 and user terminal 424 are shown as touchscreen smartphones, these displays also act as user input interfaces. It should be noted that, in some embodiments, the devices may have neither user input interface, nor displays, and may instead receive and display content using another device (e.g., a dedicated display device, such as a computer screen, and/or a dedicated input device, such as a remote control, mouse, voice input, etc.). Additionally, the devices in system 400 may run an application (or another suitable program). The application may cause the processors and/or control circuitry to perform operations related to providing rapid content switching in media assets featuring multiple content streams.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality described herein.

FIG. 4 also includes communication paths 428, 430, and 432. Communication paths 428, 430, and 432 may include the Internet, a mobile phone network, a mobile voice or data network (e.g., a 5G or LTE network), a cable network, a public switched telephone network, or other types of communications networks or combinations of communications networks. Communication paths 428, 430, and 432 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may also include control circuitry configured to perform the various operations needed to generate alternative content. For example, the cloud components 410 may include cloud-based storage circuitry configured to generate alternative content. Cloud components 410 may also include cloud-based control circuitry configured to runs processes to determine alternative content. Cloud components 410 may also include cloud-based input/output circuitry configured to present a media asset through rapid content switching between multiple content streams.

Cloud components 410 may include model 402, which may be a machine learning model (e.g., as described in FIG. 4). Model 402 may take inputs 604 and provide outputs 406. The inputs may include multiple datasets, such as a training dataset and a test dataset. Each of the plurality of datasets (e.g., inputs 404) may include data subsets related to views available to transition to. In some embodiments, outputs 406 may be fed back to model 402 as input to train model 402 (e.g., alone or in conjunction with user indications of the accuracy of outputs 406, labels associated with the inputs, or with other reference feedback information). For example, the system may receive a first labeled feature input, wherein the first labeled feature input is labeled with a known view to transition to based on the first labeled feature input. The system may then train the first machine learning model to classify the first labeled feature input with the known view.

In another embodiment, model 402 may update its configurations (e.g., weights, biases, or other parameters) based on the assessment of its prediction (e.g., outputs 406) and reference feedback information (e.g., user indication of accuracy, reference labels, or other information). In another embodiment, where model 402 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 402 may be trained to generate better predictions.

In some embodiments, model 402 may include an artificial neural network. In such embodiments, model 402 may include an input layer and one or more hidden layers. Each neural unit of model 402 may be connected with many other neural units of model 402. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 402 may be self-learning and trained, rather than explicitly programmed, and can perform significantly better in certain areas of problem solving, as compared to traditional computer programs. During training, an output layer of model 402 may correspond to a classification of model 402, and an input known to correspond to that classification may be input into an input layer of model 402 during training. During testing, an input without a known classification may be plugged into the input layer, and a determined classification may be output.

In some embodiments, model 402 may include multiple layers (e.g., where a signal path traverses from front layers to back layers). In some embodiments, back propagation techniques may be utilized by model 402 where forward stimulation is used to reset weights on the “front” neural units. In some embodiments, stimulation and inhibition for model 402 may be more free-flowing, with connections interacting in a more chaotic and complex fashion. During testing, an output layer of model 402 may indicate whether or not a given input corresponds to a classification of model 402 (e.g., a view the provides a seamless transition).

In some embodiments, model 402 may predict a series of views available to transition to in order to provide a seamless transition. For example, the system may determine that particular characteristics of a view are more likely to be indicative of a prediction. In some embodiments, the model (e.g., model 402) may automatically perform actions based on outputs 406 (e.g., select one or more views in a series of views). In some embodiments, the model (e.g., model 402) may not perform any actions. The output of the model (e.g., model 402) is only used to decide which location and/or a view to recommend.

System 400 also includes API layer 450. In some embodiments, API layer 450 may be implemented on mobile device 422 or user terminal 424. Alternatively or additionally, API layer 450 may reside on one or more of cloud components 410. API layer 450 (which may be A REST or Web services API layer) may provide a decoupled interface to data and/or functionality of one or more applications. API layer 450 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages including Ruby, Java, PHP, and JavaScript. SOAP Web services have traditionally been adopted in the enterprise for publishing internal services, as well as for exchanging information with partners in B2B transactions.

API layer 450 may use various architectural arrangements. For example, system 400 may be partially based on API layer 450, such that there is strong adoption of SOAP and RESTful Web-services, using resources like Service Repository and Developer Portal, but with low governance, standardization, and separation of concerns. Alternatively, system 400 may be fully based on API layer 450, such that separation of concerns between layers like API layer 450, services, and applications are in place.

In some embodiments, the system architecture may use a microservice approach. Such systems may use two types of layers, Front-End Layers and Back-End Layers, where microservices reside. In this kind of architecture, the role of the API layer 450 may be to provide integration between Front-End and Back-End. In such cases, API layer 450 may use RESTful APIs (exposition to front-end, or even communication between microservices). API layer 450 may use AMQP (e.g., Kafka, RabbitMQ, etc.). API layer 450 may use incipient usage of new communications protocols such as gRPC, Thrift, etc.

In some embodiments, the system architecture may use an open API approach. In such cases, API layer 450 may use commercial or open source API Platforms and their modules. API layer 450 may use developer portal. API layer 450 may use strong security constraints, applying WAF and DDOS protection, and API layer 450 may use RESTful APIs as standard for external integration.

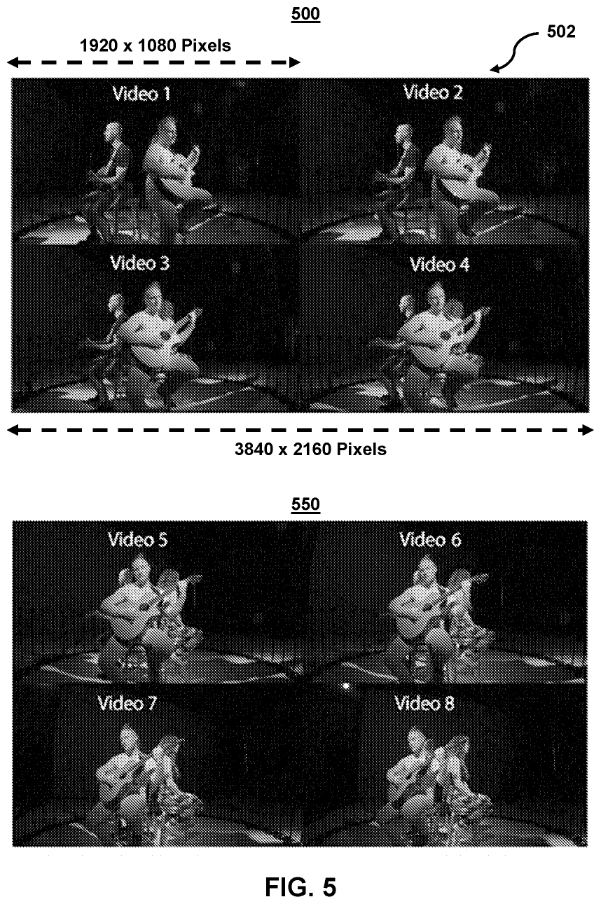

FIG. 5 is an illustrative example of a combined frame based on a plurality of content streams, in accordance with one or more embodiments. For example, FIG. 5 may include two combined frames (e.g., frame 500 and frame 550). Frame 500 may comprise a frame set, wherein the frame set comprises a first frame (e.g., frame 502) from each of the first plurality of content streams that corresponds to a first time mark in each of the first plurality of content streams.

Each of the frames in the frame set may be a reduced and/or compressed version of a frame. Each of the frames may also correspond to a portion of the combined frame. Furthermore, these portions may be shaped to fit evenly within the bounds of the combined frame when situated next to each other as shown in frame 500. For example, the system may scale frame 502 (e.g., a selected view) from 1920×1080 pixels, which corresponds to the portion of frame 500 that comprises frame 502 to a 3840×2160 pixel version. For example, the system may enhance the size and/or scale of frame 502 to fit the contours of a user interface (e.g., user interface 102 (FIG. 1)) in which the media asset is displayed. By using frames of the same size and shape in the combined frame, the system may apply the same scaling processes and factors in order to reduce processing time. For example, when a new view is selected, the system simply scales the corresponding portion of the frame of the combined stream. As there is no need to fetch a new stream (e.g., from a remote source), load, and process the new stream, the system may seamlessly transition (e.g., achieve flicker fusion) between the views.

For example, the system may apply image scaling on frame 502 to resize the digital image representing frame 502 to the size of the user interface. For example, when scaling a vector graphic image, the graphic primitives that make up the image (e.g., frame 502) can be scaled by the system, using geometric transformations, with no loss of image quality. When scaling a raster graphics image, a new image with a higher or lower number of pixels may be generated. For example, the system may scale down an original version of frame 502 to create frame 500. Likewise, the system may scale up 502 when generating it for display.

For example, frame 500 may include multiple content streams (1 through N), each taken by a content capture device organized in a matrix (e.g., mounting matrix 202 (FIG. 2), or by a camera (e.g., content capture devices 302) adjacent to each other. In this example, eight content streams are captured using adjacent content capture devices (e.g., video cameras).

Prior to being hosted on a server, local hard drive, or other component in FIG. 4, the content streams may be edited to be of equal duration and temporally synchronized. The content streams may then be arranged and embedded into a combined content stream (e.g., represented by frame 500). In this example, the content streams are compiled into two sets (e.g., represented by frame 500 and frame 550), each of which is sized at 3840×2160 pixels comprised of four 1920×1080 individual content streams with an equal duration (e.g., ten seconds, 30 minutes, 2 hours).

The two frame sets (e.g., corresponding to frame 500 and frame 550) may be uploaded to a server where the system can transfer the combined content stream to a user device, or store it on the user's local computer drive.

Prior to initiating playback, the user interface (e.g., a web browser, custom app, or standalone video player) may load each combined content stream into a separate instantiation of a player, and temporally synchronizes the combined content streams. Additionally or alternatively, the system may open additional instances of a local player and synchronize the various combined content streams. The system may balance the number of instances of a local player and the number of combined streams based on resources available to the system.

Upon the initiation of playback, which may be initiated either based on the receipt of a command from the user, or via software embedded in the user interface (e.g., web browser, media player, or custom application), the system may generate a content stream. During playback, the system may generate for display a single content stream of the combined content streams (and/or scale the content stream to the contours of the user interface). For example, in FIG. 5, the top left content steam (e.g., “Video 1”) in frame 500 is made visible in the user's media player or browser and begins playing.

Because all content streams (and/or combined content streams) are temporally synchronized, they continue to stream in their separate instantiations, and maintain synchronization even though all content streams (and/or combined content streams), with the exception of the top left content steam (e.g., “Video 1”) in frame 500, are hidden from the user's view by the system.

The displayed content stream will be the same or similar resolution to the native resolution of each video (e.g., 1920×1080 pixels), and the content streams (and/or combined content streams) retain all of the functionality of the user interface (e.g., a web browser, video player, etc.), such as playback options. The system also provides additional controls, such as, but not limited to, switching the view from “Video N” to N+1, switching the view from “Video N” to N−1, switching the view from “Video N” to N+ at a preset, customizable rate (e.g., corresponding to a playlist), and zooming in on a portion of the video.

The system may perform these functions in response to the receipt of a mouse-clicking the appropriate function by a user, tapping the screen, dragging a section of the screen, or via keyboard shortcuts. As noted below (e.g., in the playlist embodiment), these functions may also be triggered by pre-written commands stored in a file accessible by the system.

For example, if the user wishes to switch the view from “Video N” to “Video N+1,” the system hides the currently visible content stream (e.g., corresponding to one view) and causes the user's screen (e.g., user interface 102 (FIG. 1)) to display “Video N+1”. Because the current combined content stream is wholly loaded into memory (e.g., of a local device), the system may achieve this switching at high speeds that achieve flicker fusion rates with no synchronization issues or dropping of frames. The process may be repeated for “Video N+2,” or back to “Video N,” N−1, etc. using controls supplied by the system.

When, in this example, the displayed content stream is the last of a combined content stream (“Video #4”) corresponding to frame 500, and the system receives a signal to play “Video #5” (the first content stream of the combined content stream corresponding to frame 550), the system switches to the second instantiation of a user interface (e.g., a second instantiation of a web browser, video player, or standalone video player (which contains the combined content stream corresponding to frame 550), and seamlessly displays “Video #5.”

When the final content stream of the combined content stream corresponding to frame 550 is reached, the system reverts to the first instantiation (e.g., the first user interface) that includes the combined content stream corresponding to frame 500. The process of switching content streams may be repeated in either direction under the system and/or user control until the video ends.

It should be noted that the content streams may be organized in any manner of configurations in the combined content stream. For example, N content streams in a horizontal or vertical scheme, or in a matrix with N content streams across and N content streams down. Additionally or alternatively, the resolution of the content streams may be adjusted (either in pre-production or automatically by the system) to accommodate bandwidth and functionality of the server-player combination.

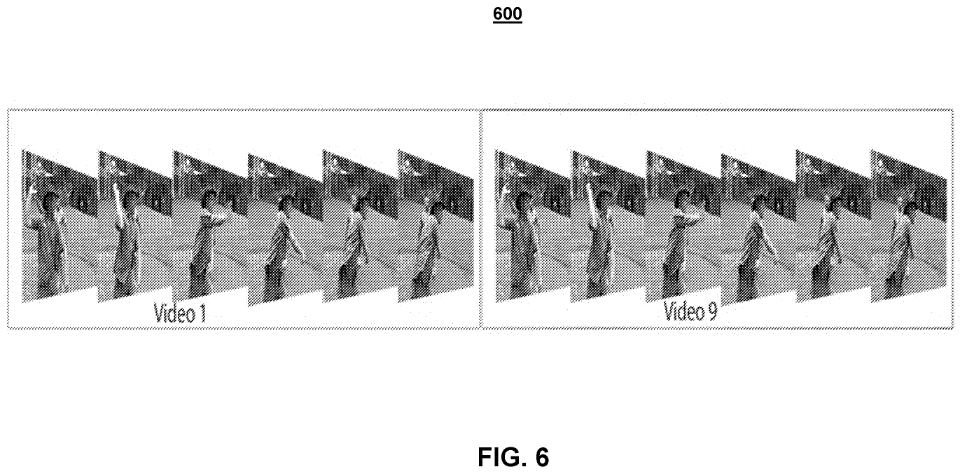

FIG. 6 is an illustrative example of a concatenated combined frame based on a plurality of content streams, in accordance with one or more embodiments. For example, in some embodiments, a combined content stream may comprise a plurality of content streams for the media asset that are concatenated by appending one content stream onto the end of another as shown in combined content stream 600. For example, each content stream of a second plurality of content streams may be appended to one of a first plurality of content streams.

For example, while there is no limit on the number of content streams that can be embedded into a single combined content stream (and/or is no limit on the number of frames that can be embedded into a single combined frame) as well as no limit on the number of combined content streams that may be loaded into separate instantiations of a user interface (e.g., a video playback system), technical limitations may be imposed by server speed, transmission bandwidth, and/or memory of a user device. The system may mitigate some of the inherent memory/bandwidth limitations when instantiating more than a given number of user interfaces (e.g., processing a respective combined content stream) into memory at the same time.

For example, as a non-limiting embodiment, if a computer/server imposes (e.g., based on technical limitations) a maximum number of two instantiations of a user interface (e.g., video players), and that each contains a combined content stream (e.g., each comprising four individual content streams as described above), there is a limit of eight content streams (e.g., corresponding to eight videos corresponding to eight views).

Accordingly, to embed additional content streams (e.g., sixteen content streams-corresponding to sixteen videos having different views) within the two user interface instantiations, the system may concatenate content streams. As shown in FIG. 6, “Video 9” is appended to the end of “Video 1.” Using this method, the system may add additional content streams. For example, “Video 9+N” may be appended to the end of “Video 1+N.” Furthermore, the system may load each combine content stream into a separate instance of a user interface (e.g., a web browser or media player), synchronize the combined content streams so that they are all playing the same frame, and generate for displays only a first frame of top left video of combined content stream 600 (e.g., comprising “Video 1” and “Video 9”).

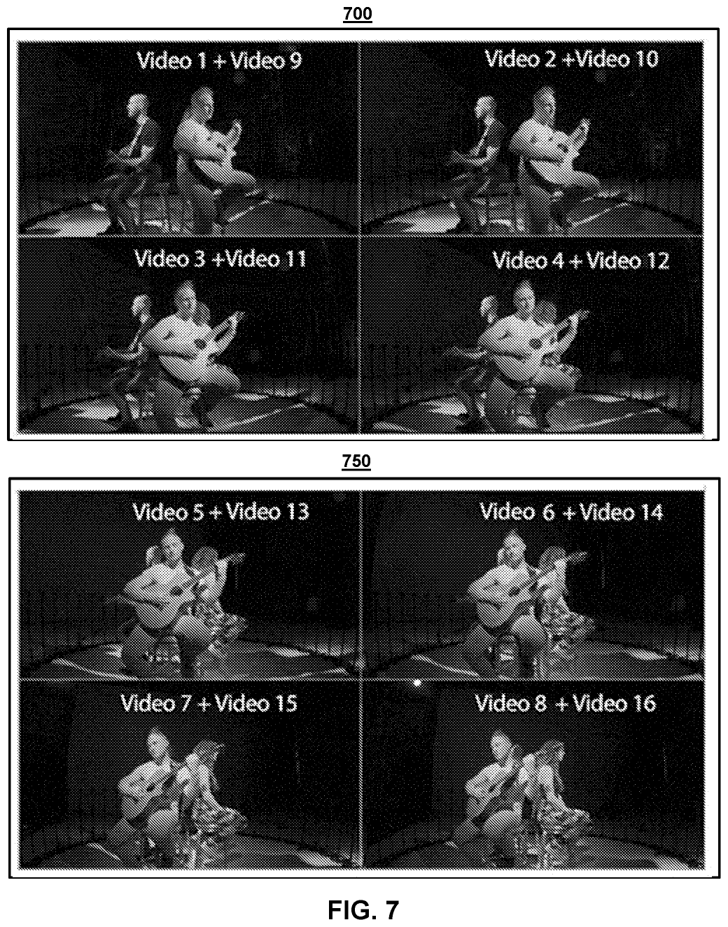

FIG. 7 is an illustrative example of a pair of concatenated, combined frames based on a plurality of content streams, in accordance with one or more embodiments. For example, upon receipt by the system of a user request, the system switches the display to “Video 2+Video 10” from “Video 1+Video 9.” The system may repeat this process, in either direction, as many times as the user desires.

When the displayed content stream is the last in the sequence on a given combined content stream (e.g., in this example, combined content stream 700, “Video 4-12”, the system switches to display the first content stream in combined content stream 750 (“Video 5+Video 13”), and begins to re-synchronize the timing of the combined content stream 700. Accordingly, the timing pointer of combined content stream 700 is positioned at the same temporal point in the second half of the concatenated content streams in combined content stream 700.

For example, if the duration of the media asset is ten seconds, all content streams have the same duration (e.g., ten seconds). The system positions the pointer in combined content stream 700 at the current display time (e.g., “Current Time”+10 seconds) in the second half of combined content stream 700 (e.g., the half corresponding to the appended content streams). The system may perform this process in the background and out of the user's view in the user interface. In this way, the pointer is temporally synchronized, and maintains this synchronization so that when the system eventually accesses the second half of content stream 700, no frames will appear to have dropped.

For example, the system may load each combined content stream into a unique instantiation of a user interface (e.g., with the browser's internal video player). The system may temporally synchronize all combined content streams. The system may then begin playing all combined content streams and maintain temporal synchronization (e.g., even though only a single content stream is visible). The system may display (e.g., “Video #1”) in a first combined content stream, while hiding all other content streams and/or combined content streams. Upon receiving a user input (e.g., requesting a change of view and/or zoom), the system switches the display to reveal “Video N+1.” Upon receiving a second user input (e.g., requesting a change of view and/or zoom), the system increments the number of the content stream to be displayed. When the displayed content stream is the last content stream in a given combined content stream, the system may trigger the display of the next content stream in the sequence. Accordingly, the system switches to the next user interface instantiation, and displays the first content stream in the combined content stream N+1. If there are no more combined content streams, the system switches back to the first combined content stream. Concurrently, the system re-synchronizes the hidden combined content streams so that they are playing at Current Time+Duration.

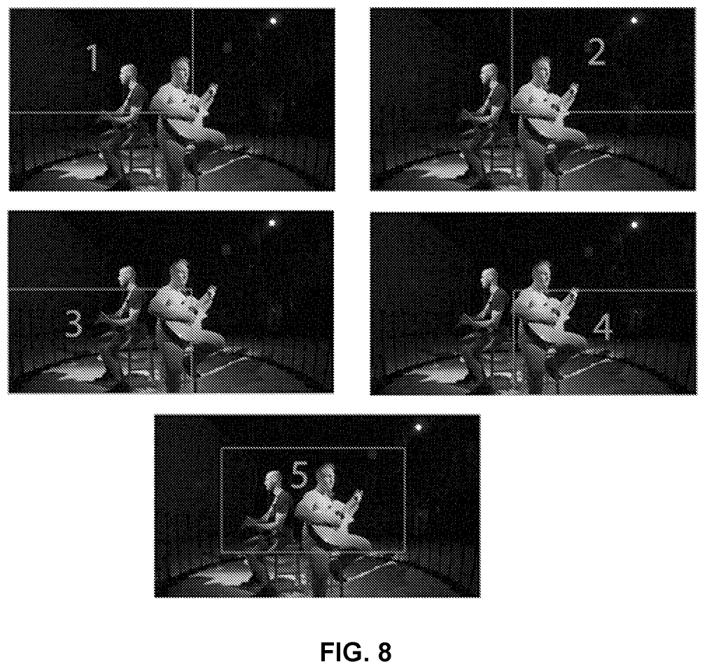

FIG. 8 is an illustrative example of selecting an area of a frame for zooming upon, in accordance with one or more embodiments. For example, in some embodiments, the system may allow a user to invoke a zoom function. The system may then determine the series of views to transition through when switching from a current view to a new view based on a number of total content streams available for the media asset in order to preserve the zoom view. For example, the system may allow a user to select a level of zoom. The amount of the zoom may be variable, and the area revealed by the zoom (e.g., top left or bottom right) may be chosen by the user (e.g., mouse clicking, screen tapping, voice commands, etc.). These zoom areas may be configurable in any manner, including multiple zoom magnifications, and placed in any portion of the video, as shown in FIG. 8.

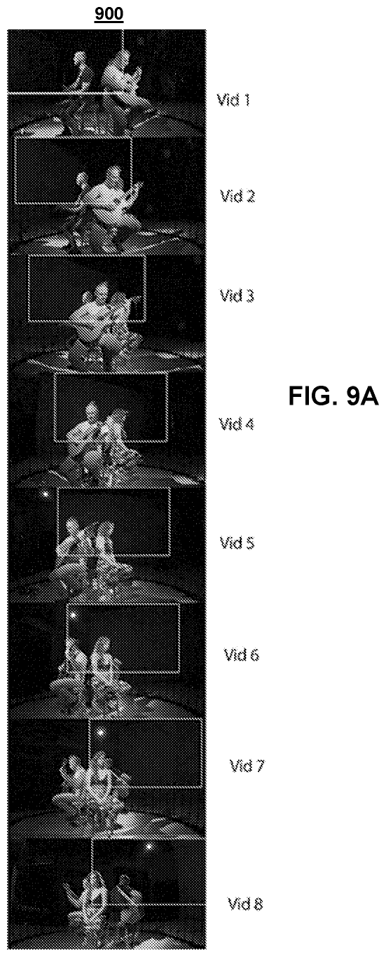

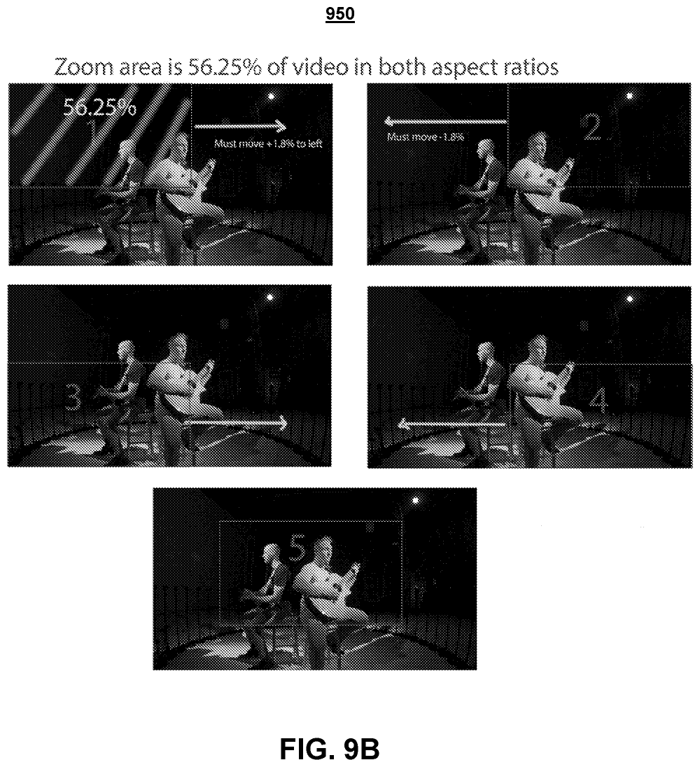

However, because the playback of a scene featured in a series of content streams may be captured with multiple content capture devices configured in any number of spatial arrangements, a conventional zoom operation into, e.g., the top right may not suffice because this area of interest will necessarily shift as the user selects different viewing angles. In view of this, the system may transition through a series of views as described in FIGS. 9A-B.

FIG. 9A is an illustrative example of determining a series of views to transition through when switching between views, in accordance with one or more embodiments. For example, the system may receive a first user input, wherein the first user input selects a first view at which to present the media asset. The system may determine a current view at which the media asset is being presented. The system may determine a series of views to transition through when switching from the current view to the first view. The system may determine a content stream corresponding to each of the series of views.

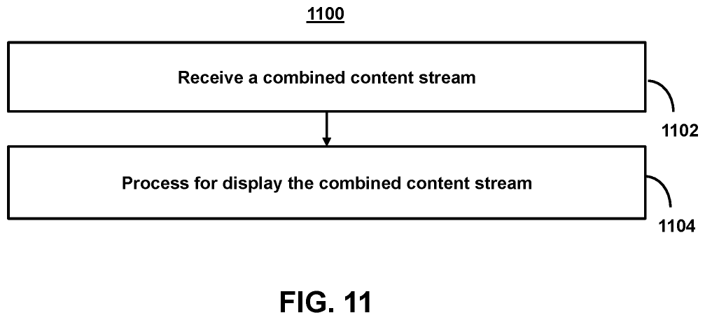

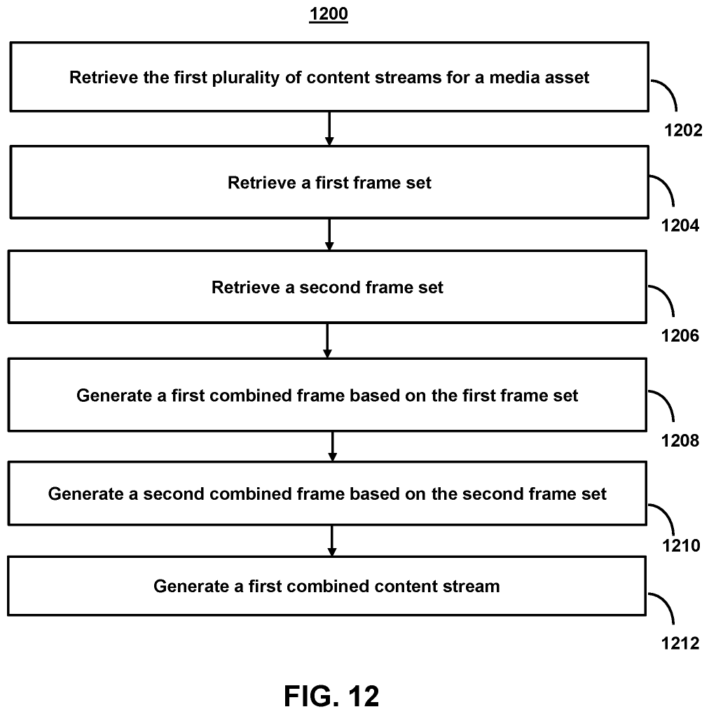

For example, FIG. 9A shows transition 900. In the example of FIG. 9A, the system may use a media asset captured using sixteen content capture devices arranged in a circle having filmed a scene (e.g., three people sitting on chairs). In this case, the user wishes to zoom into the top left area (e.g., “Vid 1”) occupied predominantly by the bald musician. When the next content stream in the sequence is viewed (e.g., while transitioning views as described in FIGS. 11-12), the zoom area is incrementally moved (e.g., as shown in “Vid 2”) so that by the time the user interface is displaying “Vid 8” (e.g., 180 degrees of the circle), the zoom area is now at the top right, which maintains the general location of the person originally selected.

For example, the system may receive a first user input, wherein the first user input selects a first view at which to present the media asset. The first view may include a particular viewing angle and/or level of zoom. The system may then determine a current view and zoom level at which the media asset is currently being presented. Based on the current view and zoom level, the system may determine a series of views and corresponding zoom levels to transition through when switching from the current view to the first view. The system may determine both the views and level of zoom for each view in order to preserve the seamless transitions between view. The system may then determine a content stream corresponding to each of the series of views. After which, the system may automatically transition through the content streams corresponding to the views while automatically adjust a level of zoom based on the determine level of zoom for each view.

FIG. 9B shows transition 900 and provides an illustrative description of the operations being performed to select the level of zoom in order to achieve the effects of FIG. 9A. For example, in the example of FIG. 9B, the system may use a media asset captured using forty-eight content capture devices arranged in a circle having filmed a scene (e.g., three people sitting on chairs). Assuming for simplicity of the example, this example assumes that the user has a choice between five regions of zoom. Top left, top right, bottom left, bottom right and center. It should be noted that these operations would apply for examples with additional regions and/or applied with an arbitrary zoom area and magnification.

As shown in transition 950, the system receives (e.g., via a user input) a selection of a first zoom area for a first content capture device. As shown, the first zoom are covers 56.25% of the frame of “Vid 1.” In response to the system receiving a subsequent selection (e.g., via another user input), the system switches to a second content capture device (e.g., content capture device 1+N), and the zoom area is shifted to a second zoom area. As shown the second content capture device represents the twenty-forth content capture device of the forty eight content capture devices. As such, the view now appears on the right side of the scene in “Vid 2.”

To achieve this effect, the system uses a calculation based on a percentage of the entire frame. For example, in this case, the calculation for the amount of lateral increment (to the right) per content capture device corresponds to the difference in percentage per content capture device. In this example, the system determines that the calculation is: ((100%−56.25%)/24)=1.8%.

When the system reaches content capture device 24, the zoom position will be as shown in “Vid 2.” Completing the circuit results in, the increment being reversed by 1.8% so that when content capture device 48 is reached, the zoom is in the same place as the starting position. The system may repeat this process for the transition from “Vid 3” to “Vid 4.” While no incrementation is necessary for if a central area of zoom is selected, as shown in “Vid 5.”

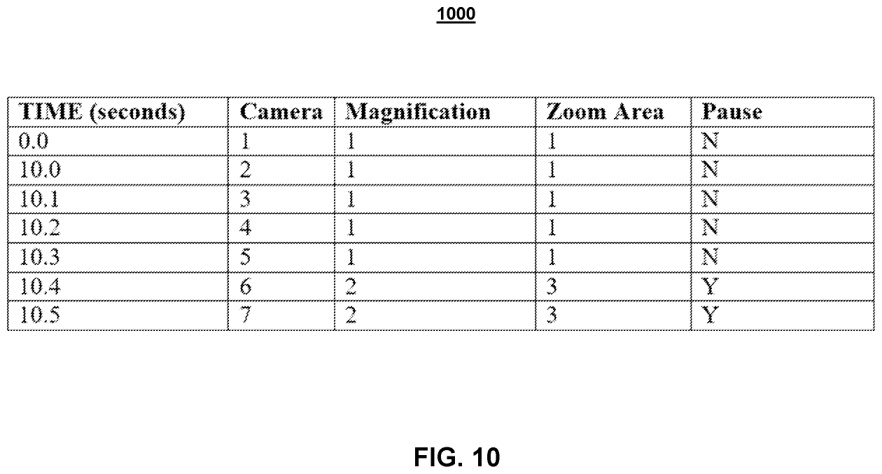

FIG. 10 is an illustrative example of a playlist of a series of views, in accordance with one or more embodiments. For example, in some embodiments, the system may receive a playlist, wherein the playlist comprises pre-selected views at which to present the media asset. The system may then determine a view (and a corresponding content stream to display) based on the playlist. For example, in order to provide a “Director's Cut” feature, the system may load a playlist comprising specific views and other characteristics (e.g., levels of magnification, zoom, etc.) corresponding to different time marks.

For example, the system may load playlist 1000. Playlist 1000 may cause the system to use predetermined controls of the content stream features, including but not limited to, rate of change of the selection of content stream, direction of content stream selection (left/right), zoom functionality, pause/play, etc.

Accordingly, the user can optionally view the functionality of the system without activating any controls. For example, the system may allow users to optionally record their own playback preferences and create their own “director's cut” for sharing with other viewers. The system may be achieved in a number of ways, and one example is the creation and storage on a server or user's computer of a text file with specific directions that the system can load and execute. For example, the system may receive a series of a playlist, wherein the playlist comprises pre-selected views at which to present the media asset. The system may then determine a current view for presenting based on the playlist. In some embodiments, the system may monitor the content streams view by a user during playback of a media asset. For example, the system may tag each frame with an indication that it was used by the user in a first combined content stream. The system may aggregate the tagged frames into a playback file. Furthermore, the system may automatically compile this file and/or automatically share it with other users (e.g., allowing other users to view the media asset using the same content stream selections as the user).

FIG. 11 shows a flowchart of the steps involved in providing rapid content switching in media assets featuring multiple content streams that are delivered over computer networks, in accordance with one or more embodiments. For example, the system may use process 1100 (e.g., as implemented on one or more system components) in order to provide rapid content switching.

At step 1102, process 1100 (e.g., using one or more components described in system 400 (FIG. 4)) receives a combined content stream. For example, the system may receive a first combined content stream based on a first combined frame and a second combined frame. For example, the first combined frame may be based on a first frame set, wherein the first frame set comprises a first frame from each of a first plurality of content streams that corresponds to a first time mark in each of the first plurality of content streams. The second combined frame may be based on a second frame set, wherein the second frame set comprises a second frame from each of the first plurality of content streams that corresponds to a second time mark in each of the first plurality of content streams. The first plurality of content streams is for a media asset, wherein each content stream of the first plurality of content streams corresponds to a respective view of a scene in the media asset.

At step 1104, process 1100 (e.g., using one or more components described in system 400 (FIG. 4)) processes for display the combined content stream. For example, the system may process for display, in a first user interface of a user device, the first combined content stream. For example, the system may process the combined content stream by selecting one of the views included in the combined content stream, and generate only a frame corresponding to that view.

For example, the system may receive a first user input, wherein the first user input selects a first view at which to present the media asset. The system may then determine that a first content stream of the first plurality of content streams corresponds to the first view. In response to determining that the first content stream of the first plurality of content streams corresponds to the first view, the system may determine a location, in a combined frame of the first combined content stream, that corresponds to frames from the first content stream. The system may scale the location to a display area of the first user interface of the user device. For example, the system may scale the location to the display area of the first user interface of the user device by generating for display, to the user, the frames from the first content stream, and not generating for display, to the user, frames from other content streams of the first plurality of content streams. The system may generate for display, in the first user interface of the user device, the location as scaled to the display area of the first user interface of the user device.

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, each of these steps may be performed in any order, in parallel, or simultaneously to reduce lag or increase the speed of the system or method. Furthermore, it should be noted that any of the devices or equipment discussed in relation to FIGS. 1-10 and 12 could be used to perform one or more of the steps in FIG. 11.

FIG. 12 shows a flowchart of the steps involved in generating media assets featuring multiple content streams, in accordance with one or more embodiments. For example, the system may use process 1200 (e.g., as implemented on one or more system components) in order to provide rapid content switching.

At step 1202, process 1200 (e.g., using one or more components described in system 400 (FIG. 4)) retrieves the first plurality of content streams for a media asset. For example, the system may retrieve a first plurality of content streams for a media asset, wherein each content stream of the first plurality of content streams corresponds to a respective view of a scene in the media asset. The first plurality of content streams may be stored and/or transferred from a remote location. In some embodiments, each content stream may also have a corresponding audio track (e.g., captured with the same content capture device (e.g., via a microphone) as the content stream.

At step 1204, process 1200 (e.g., using one or more components described in system 400 (FIG. 4)) retrieves a first frame set. For example, the system may retrieve a first frame set, wherein the first frame set comprises a first frame from each of the first plurality of content streams that corresponds to a first time mark in each of the first plurality of content streams.

At step 1206, process 1200 (e.g., using one or more components described in system 400 (FIG. 4)) retrieves a second frame set. For example, the system may retrieve a second frame set, wherein the second frame set comprises a second frame from each of the first plurality of content streams that corresponds to a second time mark in each of the first plurality of content streams.

At step 1208, process 1200 (e.g., using one or more components described in system 400 (FIG. 4)) generates a first combined frame based on the first frame set. For example, the system may generate a first combined frame based on the first frame set. For example, the first combined frame may comprise a respective portion that corresponds to each frame in the first frame set (e.g., as shown in FIG. 5). For example, the first plurality of content streams comprises four content streams, and wherein the first combined frame comprises an equal portion for the first frame from each of the first plurality of content streams.

At step 1210, process 1200 (e.g., using one or more components described in system 400 (FIG. 4)) generates a second combined frame based on the second frame set. For example, the system may generate a second combined frame based on the second frame set. For example, the second combined frame may comprise a respective portion that corresponds to each frame in the second frame set (e.g., as shown in FIG. 5). For example, the second plurality of content streams comprises four content streams, and wherein the first combined frame comprises an equal portion for the first frame from each of the first plurality of content streams.

At step 1212, process 1200 (e.g., using one or more components described in system 400 (FIG. 4)) generates a first combined content stream. For example, the system may generate a first combined content stream based on the first combined frame and the second combined frame. In some embodiments (e.g., as described in FIG. 6), the first combined content stream may comprise a third plurality of content streams for the media asset, wherein each content stream of the third plurality of content streams corresponds to a respective view of the scene in the media asset, and wherein each content stream of the third plurality of content streams is appended to one of the first plurality of content streams.

It is contemplated that the steps or descriptions of FIG. 12 may be used with any other embodiment of this disclosure. In addition, the steps and descriptions described in relation to FIG. 12 may be done in alternative orders or in parallel to further the purposes of this disclosure. For example, each of these steps may be performed in any order, in parallel, or simultaneously to reduce lag or increase the speed of the system or method. Furthermore, it should be noted that any of the devices or equipment discussed in relation to FIGS. 1-11 could be used to perform one or more of the steps in FIG. 12.

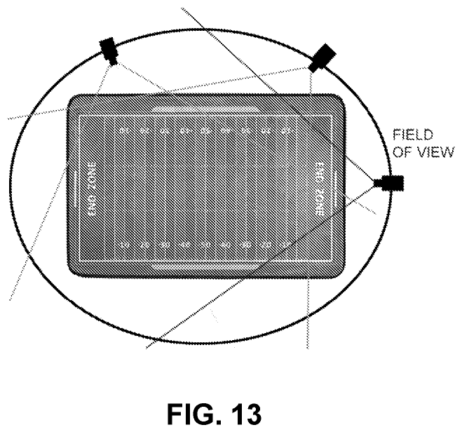

FIG. 13 is an illustrative system for generating media assets featuring multiple content streams in large areas, in accordance with one or more embodiments. For example, to achieve a 360-degree camera coverage over a large area, such as a football field, arena, studio or any indoor or outdoor environment, a plurality of cameras may be mounted at similar heights on poles, stands, hung from rafters, or other means, in a circular, elliptical, or some other arrangement around the field, with each camera having the same or similar focal length lens so that each camera's field of view is able to cover the majority of field as shown in FIG. 13.

In such cases, the system may mount all content capture devices at similar heights and have the same or similar focal lengths, so that when switching video feeds (e.g., content streams), the transition effect remains smooth and continuous. However, while the content capture device setup described above would result in a smooth, continuous rotation around the field with virtually every section of the field visible to each camera, this arrangement results in another technical hurdle. Specifically, because the focal length of each camera must be necessarily short (e.g., feature a wide angle) to accommodate coverage of the entire field, the individual players would be too small for effective viewing.

To overcome this technical hurdle, the system may concentrate on a particular area of view. For example, because the action on a large field or arena is likely concentrated in a relatively small section of the field, there is little value in recording the entire field at any one time. This is not an issue for conventional video coverage of sporting events using multiple cameras, since these cameras are uncoordinated, and each camera can zoom independently into a portion of the field.

However, in order to maintain cohesion between the zoom settings and content capture device orientations of multiple content capture devices to achieve the playback effect of rapid content switching described above, each content capture device may zoom, swivel, and/or tilt in a coordinated fashion. For example, a content capture device that is physically close to the action must have a short focal length, while a content capture device further away requires a longer focal length. In such cases, each content capture device may require movement independently of the others. Similarly, depending on a location of interest (e.g., a corner of a filed in which the action is occurring), the content capture devices may need to swivel and/or tilt in relationship to their positions and/or independently of the other content capture devices.

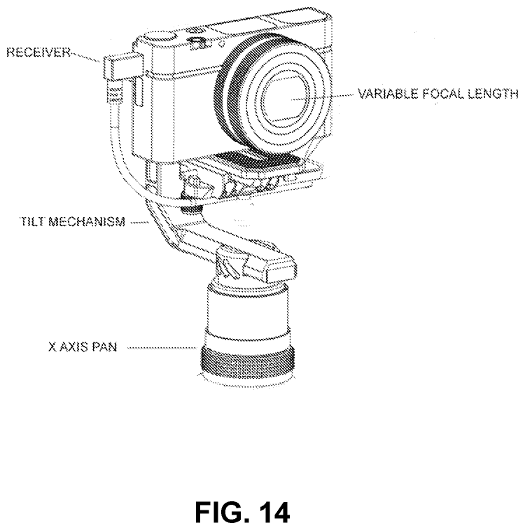

FIG. 14 shows an illustrative content capture device for generating media assets featuring multiple content streams, in accordance with one or more embodiments. For example, FIG. 14 may illustrate a mechanical means to follow action and maintain coordinated zoom, pan, and/or tilt for a matrix of content capture devices (e.g., providing rapid content switching).

For example, a playing field, arena, sporting ring, or film studio or arbitrary-sized indoor or outdoor space may be surrounded by a matrix of content capture devices mounted at similar heights and similar distances from the center of the pitch, arena, or sporting ring (e.g., as described above). Additional content capture devices may be mounted above or below each other to achieve up and down control upon playback in response to user inputs. In some embodiments, the shape and/or height of the matrix may be circular, elliptical, or any shape that corresponds to the needs of the user (e.g., a director, viewer, etc.).

Each content capture device may be mounted on a gimbal (or other mechanical means) with rotational capability in the X and Y axes (pan and tilt). Each content capture device may employ a variable zoom lens. The gimbal's pan and/or tilt settings and the content capture device's focal length may be controlled remote (e.g., via radio or other electromagnetic signal). Furthermore, the zoom, pan, and/or tilt settings for each content capture device may be automatically determined as described above.

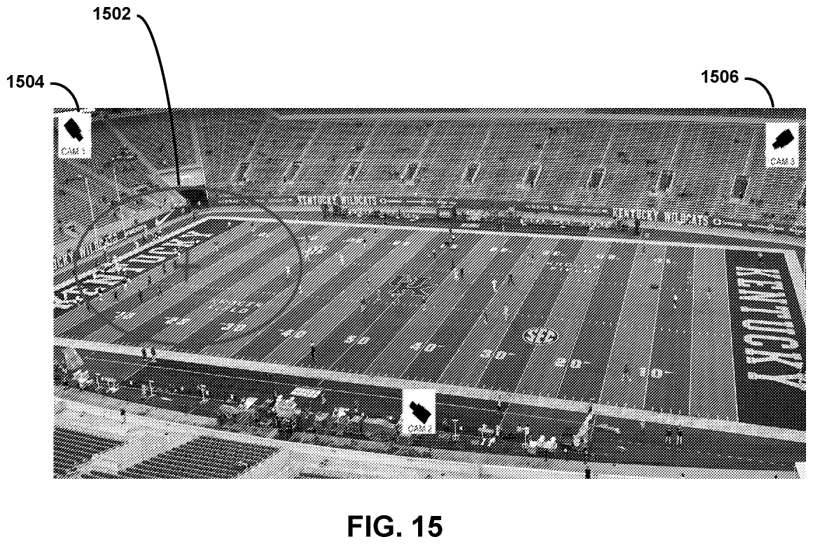

FIG. 15 is an illustrative system for generating media assets featuring multiple content streams in large areas featuring a pre-selected section with a desired field of view, in accordance with one or more embodiments. For example, when capturing scenes in a large setting in which the main action relocates to various positions within the environment over time, the system may follow the action by selecting the X, Y and Z coordinates of a single point within the area of play that corresponds to a Center of Interest (COI). The system may modify the zoom, pan, and/or tilt settings for each content capture device automatically to correspond to the COI (e.g., COI 1502).

For example, as the media asset progresses (e.g., a live recording of a game), the COI may relocate to different areas of the field. The COI may be tracked by a user and/or an artificial intelligence model that is trained to follow the action. Additionally or alternatively, the COI may be based on a position of an element that is correlated to the COI (e.g., an RFID transmitter implanted in a ball, clothing, and/or equipment of a player. The element may transmits the X, Y and Z axes of the COI to a computer program via radio or other electromagnetic signals. For example, the Z axis may be zero (e.g., ground level), but may change when it is desirable to track the ball in the event of a kick or throw.

As shown in FIG. 15, the system may determine the COI, which is highlighted as the circled area in FIG. 15. The COI may be a pre-selected arbitrary-sized section that represents the desired field of view for all content capture devices when zoomed into the scene.

When a COI is selected by a user, the user may input the X, Y, (and Z) coordinates into the system via a user interface (e.g., with a mouse or similar input device) using an image of the viewing area (e.g., field) for reference. In the case of an artificial intelligence model, the model may have been previously trained to select the COI. If an RFID embodiment is used, the system may use the actual location of the RFID chip to determine the COI and its coordinates may be transmitted directly to the system.

In order to coordinate the tilt/pan and focal length settings so that each content capture devices maintains its relationship to the COI, each content capture device may uniquely adjust its focal length depending on how far it is from the COI, and reorient the gimbal's pan/tilt so that the camera is pointing directly at the COI.

In some embodiments, the system may contain a database of the X, Y, and Z locations of each content capture device to perform a series of trigonometric calculations that returns the distance and angle of each content capture device relative to the COI. By integrating the two sets of coordinates (e.g., content capture device and COI), the system may use an algorithm that computes the gimbal settings for the X, Y pan and tilt, as well as the focal length for each content capture device so that the content capture device is pointed directly at COI and a focal length that is proportional to the distance of the COI.

The system may also generate automatic updates. For example, using radio or other electromagnetic means, the system may transmit a unique focal length to every content capture device in real-time, and the content capture device may adjust its zoom magnification accordingly. Likewise, the settings for the X axis pan, and the Y axis tilt may be transmitted to the gimbal, which adjusts the gimbal's orientation.

As shown in FIG. 15, content capture device 1504 may be closest to the action and its focal length will be the shortest (wide angle). As such, content capture device 1504 may have a gimbal that is sharply pointing down such that its center of view is directly aligned to the X, Y, and Z coordinates of COI 1502. The tilt orientation for each gimbal may be proportional to the camera's distance of the content capture device from COI 1502 (e.g., the closer the action, the more the downward tilt). While content capture devices directly adjacent to content capture device 1504 may have slightly longer focal lengths and slightly different tilt/pan settings, the settings for content capture device 1506, for example, may feature a significantly longer focal length, a more extreme pan to the left and a less extreme down-tilt.

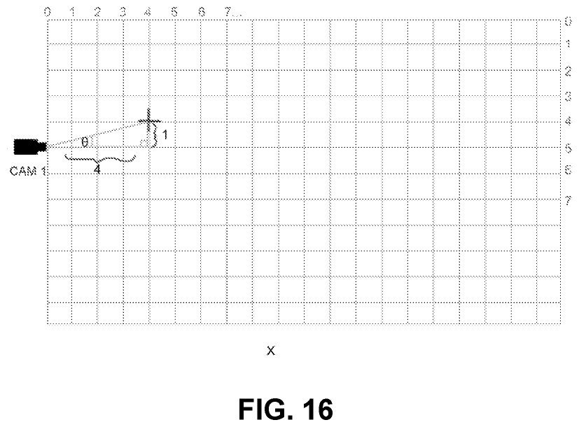

FIG. 16 shows an illustrative diagram related to calculating zoom, in accordance with one or more embodiments. For example, the focal length (zoom) settings for the content capture devices may be calculated using trigonometry functions so that the focal length is directly proportional to the physical distance between the content capture device and the COI. The trigonometric calculation may be conducted in a number of ways with one example shown in FIG. 16, where the football field is represented by a series of equally spaced squares of arbitrary size.

In this case, the COI (e.g., COI 1502 (FIG. 15)) lies on the 4,4 X, Y coordinates and the content capture device is at 0,5. The distance between the content capture device and COI 1502 may be calculated by the hypotenuse of the resultant triangle ((4\hat{ }2)+(1\hat{ }2))\hat{ }0.5=4.13. The system may determine this number, multiplied by a predefined variable that is the same for all content capture device, to define the focal length setting of the zoom lens and the resulting field of view (e.g., the higher the variable, the higher the magnification).

To calculate pan (e.g., X, Y axes), the system may determine the angle θ, which represents the amount in degrees that the gimbal should be panned (left or right) so that the COI is centered in the field of view of the content capture device. The system may determine the angle using the SIN of (¼).

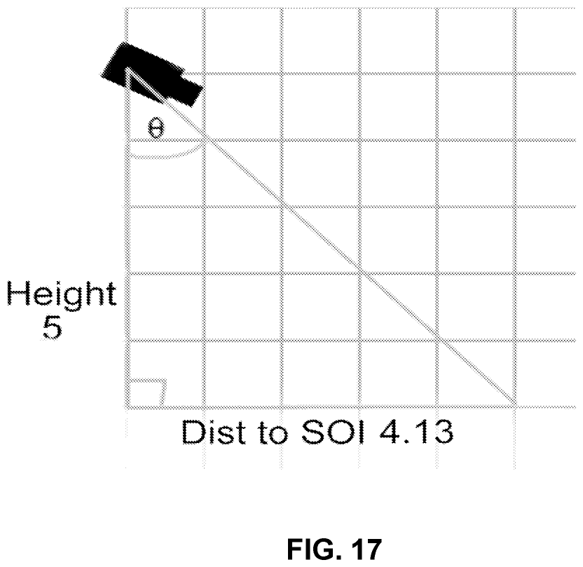

FIG. 17 shows an illustrative diagram related to calculating tilt, in accordance with one or more embodiments. To calculate tile (e.g., the X axis), the system may use the height and the distance of the content capture device to the COI (e.g., as retrieved from a database). The system may then calculate the downward tilt (θ) based on the TAN of (4.31/5) (distance over height). Furthermore, as the individual content capture devices are in fairly close proximity to each other, small changes in settings (relative to each another) may produce smooth variations in both zoom and orientation when played back.

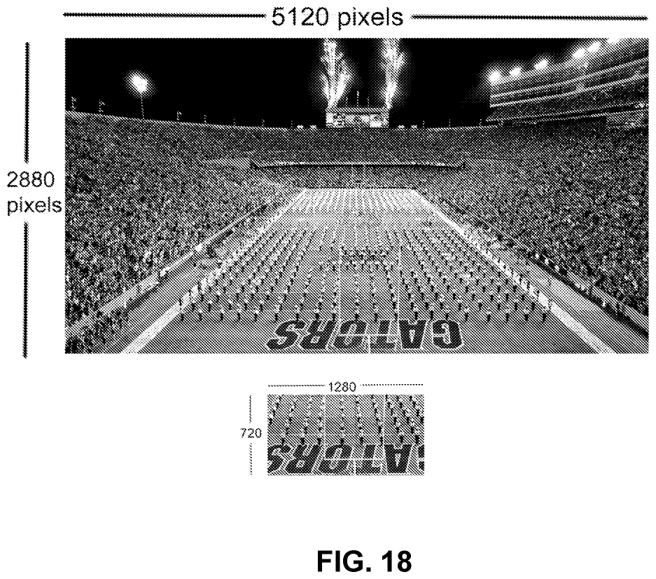

FIG. 18 shows an illustrative diagram related to post-production of media assets featuring multiple content streams, in accordance with one or more embodiments. For example, the resulting zoom magnification described in above are limited only by the optical capability of the zoom lenses on the content capture device, which commonly reaches 10 times or more. For situations where smaller zooms are desired (e.g., a boxing ring instead of a football field), the system may forgo expensive gimbals and zoom lenses by deploying a post-production digital zoom technique without loss of video quality. During post-production, the COI may be dynamically chosen by the user, a model, and/or COI coordinates, when integrated with the known position of each content capture device. The system may then trigonometrically calculate the portion of the video to be cropped. For example as shown in FIG. 18, if the final 360-degree videos are to be streamed or transmitted at 1280×720 pixels (720 HD) and the original video was recorded at 5120×2880 pixels (5K), a post production process can digitally zoom into a prescribed portion of each video and render that portion of the video at 720 HD using the trigonometric solutions as described above.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising: retrieving the first plurality of content streams for a media asset, wherein each content stream of the first plurality of content streams corresponds to a respective view of a scene in the media asset; retrieving a first frame set, wherein the first frame set comprises a first frame from each of the first plurality of content streams that corresponds to a first time mark in each of the first plurality of content streams; retrieving a second frame set, wherein the second frame set comprises a second frame from each of the first plurality of content streams that corresponds to a second time mark in each of the first plurality of content streams; generating a first combined frame based on the first frame set; generating a second combined frame based on the second frame set; and generating a first combined content stream based on the first combined frame and the second combined frame.

2. A method, the method comprising: receiving a first combined content stream based on a first combined frame and a second combined frame, wherein: the first combined frame is based on a first frame set, wherein the first frame set comprises a first frame from each of a first plurality of content streams that corresponds to a first time mark in each of the first plurality of content streams; the second combined frame is based on a second frame set, wherein the second frame set comprises a second frame from each of the first plurality of content streams that correspond to a second time mark in each of the first plurality of content streams; and the first plurality of content streams is for a media asset, wherein each content stream of the first plurality of content streams corresponds to a respective view of a scene in the media asset; and processing for display, on a first user interface of a user device, the first combined content stream.

3. The method of any of the preceding embodiments, further comprising: receiving a first user input, wherein the first user input selects a first view at which to present the media asset; determining that a first content stream of the first plurality of content streams corresponds to the first view; in response to determining that the first content stream of the first plurality of content streams corresponds to the first view, determining a location, in a combined frame of the first combined content stream, that corresponds to frames from the first content stream; scaling the location to a display area of the first user interface of the user device; generating for display, in the first user interface of the user device, the location as scaled to the display area of the first user interface of the user device.

4. The method of any of the preceding embodiments, wherein scaling the location to the display area of the first user interface of the user device comprises generating, for display to the user, the frames from the first content stream, and not generating for display to the user, frames from other content streams of the first plurality of content streams.

5. The method of any of the preceding embodiments, further comprising: receiving a second combined content stream based on a third combined frame and a fourth combined frame, wherein: the third combined frame is based on a third frame set, wherein the third frame set comprises a first frame from each of a second plurality of content streams that corresponds to the first time mark in each of the second plurality of content streams; the second combined frame is based on the second frame set, wherein the second frame set comprises a second frame from each of the second plurality of content streams that corresponds to a second time mark in each of the second plurality of content streams; and the first plurality of content streams is for the media asset, wherein each content stream of the first plurality of content streams corresponds to a respective view of the scene in the media asset; and processing for display, in a second user interface of a user device, the second combined content stream, wherein second combined content stream is processed simultaneously with the first combined content stream.

6. The method of any of the preceding embodiments, further comprising: receiving a second user input, wherein the second user input selects a second view at which to present the media asset; determining that a second content stream of the second plurality of content streams corresponds to the second view; in response to determining that the second content stream of the second plurality of content streams corresponds to the second view, replacing the first user interface with the second user interface.

7. The method of any of the preceding embodiments, wherein the first plurality of content streams comprises four content streams, and wherein the first combined frame comprises an equal portion for the first frame from each of the first plurality of content streams.

8. The method of any of the preceding embodiments, wherein the first combined content stream comprises a third plurality of content streams for the media asset, wherein each content stream of the third plurality of content streams corresponds to a respective view of the scene in the media asset, and wherein each content stream of the third plurality of content streams is appended to one of the first plurality of content streams.

9. The method of any of the preceding embodiments, further comprising: receiving a playlist, wherein the playlist comprises pre-selected views at which to present the media asset; and determining a current view for presenting based on the playlist.

10. The method of any of the preceding embodiments, further comprising: receiving a first user input, wherein the first user input selects a first view at which to present the media asset; determining a current view at which the media asset is currently being presented; determining a series of views to transition through when switching from the current view to the first view; and determining a content stream corresponding to each of the series of views.

11. The method of any of the preceding embodiments, wherein the series of views to transition through when switching from the current view to the first view is based on a number of total content streams available for the media asset.

12. A tangible, non-transitory, machine-readable medium storing instructions that, when executed by a data processing apparatus, cause the data processing apparatus to perform operations comprising those of any of embodiments 1-11.

13. A system comprising: one or more processors; and memory storing instructions that, when executed by the processors, cause the processors to effectuate operations comprising those of any of embodiments 1-11.

14. A system comprising means for performing any of embodiments 1-11.

What is claimed is:

1. A system for providing rapid content switching in media assets featuring multiple content streams that are delivered over computer networks, the system comprising:
cloud-based storage circuitry configured to store a first plurality of content streams;
cloud-based control circuitry configured to:
retrieve the first plurality of content streams for a media asset, wherein each content stream of the first plurality of content streams corresponds to a respective view of a scene in the media asset;
retrieve a first frame set, wherein the first frame set comprises a first frame from each of the first plurality of content streams that corresponds to a first time mark in each of the first plurality of content streams;
retrieve a second frame set, wherein the second frame set comprises a second frame from each of the first plurality of content streams that corresponds to a second time mark in each of the first plurality of content streams;
generate a first combined frame based on the first frame set;
generate a second combined frame based on the second frame set;
generate a first combined content stream based on the first combined frame and the second combined frame;
receive a first user input, wherein the first user input selects a first view at which to present the media asset for display in a first user interface of a user device;
determine that a first content stream of the first plurality of content streams corresponds to the first view;
in response to determining that the first content stream of the first plurality of content streams corresponds to the first view, determine a location, in a combined frame of the first combined content stream, that corresponds to frames from the first content stream;
scale the location to a display area of the first user interface of the user device, wherein scaling the location to the display area of the first user interface of the user device comprises generating for display, to a user, the frames from the first content stream, and not generating for display, to the user, frames from other content streams of the first plurality of content streams; and
input/output circuitry configured to generate for display, in the first user interface of the user device, the location as scaled to the display area of the first user interface of the user device.

2. A method for providing rapid content switching in media assets featuring multiple content streams that are delivered over computer networks, the method comprising:
receiving a first combined content stream based on a first combined frame and a second combined frame, wherein:
the first combined frame is based on a first frame set, wherein the first frame set comprises a first frame from each of a first plurality of content streams that corresponds to a first time mark in each of the first plurality of content streams;
the second combined frame is based on a second frame set, wherein the second frame set comprises a second frame from each of the first plurality of content streams that corresponds to a second time mark in each of the first plurality of content streams; and
the first plurality of content streams is for a media asset, wherein each content stream of the first plurality of content streams corresponds to a respective view of a scene in the media asset; and
processing for display, in a first user interface of a user device, the first combined content stream.

3. The method of claim 2, further comprising:
receiving a first user input, wherein the first user input selects a first view at which to present the media asset;
determining that a first content stream of the first plurality of content streams corresponds to the first view;
in response to determining that the first content stream of the first plurality of content streams corresponds to the first view, determining a location, in a combined frame of the first combined content stream, that corresponds to frames from the first content stream;
scaling the location to a display area of the first user interface of the user device;
generating for display, in the first user interface of the user device, the location as scaled to the display area of the first user interface of the user device.

4. The method of claim 3, wherein scaling the location to the display area of the first user interface of the user device comprises generating for display to a user the frames from the first content stream and not generating for display to the user frames from other content streams of the first plurality of content streams.

5. The method of claim 2, further comprising:
receiving a second combined content stream based on a third combined frame and a fourth combined frame, wherein:
the third combined frame is based on a third frame set, wherein the third frame set comprises a first frame from each of a second plurality of content streams that corresponds to the first time mark in each of the second plurality of content streams;
the second combined frame is based on the second frame set, wherein the second frame set comprises a second frame from each of the second plurality of content streams that corresponds to a second time mark in each of the second plurality of content streams; and
the first plurality of content streams is for the media asset, wherein each content stream of the first plurality of content streams corresponds to a respective view of the scene in the media asset; and
processing for display, in a second user interface of a user device, the second combined content stream, wherein the second combined content stream is processed simultaneously with the first combined content stream.

6. The method of claim 5, further comprising:
receiving a second user input, wherein the second user input selects a second view at which to present the media asset;
determining that a second content stream of the second plurality of content streams corresponds to the second view;
in response to determining that the second content stream of the second plurality of content streams corresponds to the second view, replacing the first user interface with the second user interface.

7. The method of claim 2, wherein the first plurality of content streams comprises four content streams, and wherein the first combined frame comprises an equal portion for the first frame from each of the first plurality of content streams.

8. The method of claim 2, wherein the first combined content stream comprises a third plurality of content streams for the media asset, wherein each content stream of the third plurality of content streams corresponds to a respective view of the scene in the media asset, and wherein each content stream of the third plurality of content streams is appended to one of the first plurality of content streams.

9. The method of claim 2, further comprising:
receiving a playlist, wherein the playlist comprises pre-selected views at which to present the media asset, and wherein the pre-selected views were automatically determine based on the first combined content stream; and
determining a current view for presenting based on the playlist.

10. The method of claim 2, further comprising:
receiving a first user input, wherein the first user input selects a first view at which to present the media asset;
determining a current view and zoom level at which the media asset is currently being presented;
determining a series of views and corresponding zoom levels to transition through when switching from the current view to the first view; and
determining a content stream corresponding to each of the series of views.

11. The method of claim 10, wherein the series of views to transition through when switching from the current view to the first view is based on a number of total content streams available for the media asset.

12. The method of claim 2, further comprising:
determining a combined audio track to present with the first combined content stream, wherein the combined audio track comprises a first audio track corresponding to the first combined frame and a second audio track corresponding the second combined frame, wherein the first audio track is captured with a content capture device that captured the first frame set, and wherein the second audio track is captured with a content capture device that captured the second frame set.

13. A non-transitory, computer readable medium for providing rapid content switching in media assets featuring multiple content streams that are delivered over computer networks comprising instructions that, when executed by one or more processors, cause operations comprising:
receiving a first combined content stream based on a first combined frame and a second combined frame, wherein:
the first combined frame is based on a first frame set, wherein the first frame set comprises a first frame from each of a first plurality of content streams that corresponds to a first time mark in each of the first plurality of content streams;
the second combined frame is based on a second frame set, wherein the second frame set comprises a second frame from each of the first plurality of content streams that corresponds to a second time mark in each of the first plurality of content streams; and
the first plurality of content streams is for a media asset, wherein each content stream of the first plurality of content streams corresponds to a respective view of a scene in the media asset; and
processing for display, in a first user interface of a user device, the first combined content stream.

14. The non-transitory, computer readable media of claim 13, wherein the instructions further cause operations comprising:
receiving a first user input, wherein the first user input selects a first view at which to present the media asset;
determining that a first content stream of the first plurality of content streams corresponds to the first view;
in response to determining that the first content stream of the first plurality of content streams corresponds to the first view, determining a location, in a combined frame of the first combined content stream, that corresponds to frames from the first content stream;
scaling the location to a display area of the first user interface of the user device;
generating for display, in the first user interface of the user device, the location as scaled to the display area of the first user interface of the user device.

15. The non-transitory, computer readable media of claim 14, wherein scaling the location to the display area of the first user interface of the user device comprises generating for display to a user the frames from the first content stream and not generating for display to the user frames from other content streams of the first plurality of content streams.

16. The non-transitory, computer readable media of claim 13, wherein the instructions further cause operations comprising:
receiving a second combined content stream based on a third combined frame and a fourth combined frame, wherein:
the third combined frame is based on a third frame set, wherein the third frame set comprises a first frame from each of a second plurality of content streams that corresponds to the first time mark in each of the second plurality of content streams;
the second combined frame is based on the second frame set, wherein the second frame set comprises a second frame from each of the second plurality of content streams that corresponds to a second time mark in each of the second plurality of content streams; and
the first plurality of content streams is for the media asset, wherein each content stream of the first plurality of content streams corresponds to a respective view of the scene in the media asset; and
processing for display, in a second user interface of a user device, the second combined content stream, wherein second combined content stream is processed simultaneously with the first combined content stream.

17. The non-transitory, computer readable media of claim 16, wherein the instructions further cause operations comprising:
receiving a second user input, wherein the second user input selects a second view at which to present the media asset;
determining that a second content stream of the second plurality of content streams corresponds to the second view;
in response to determining that the second content stream of the second plurality of content streams corresponds to the second view, replacing the first user interface with the second user interface.

18. The non-transitory, computer readable media of claim 13, wherein the first plurality of content streams comprises four content streams, and wherein the first combined frame comprises an equal portion for the first frame from each of the first plurality of content streams.

19. The non-transitory, computer readable media of claim 13, wherein the first combined content stream comprises a third plurality of content streams for the media asset, wherein each content stream of the third plurality of content streams corresponds to a respective view of the scene in the media asset, and wherein each content stream of the third plurality of content streams is appended to one of the first plurality of content streams.

20. The non-transitory, computer readable media of claim 13, wherein the instructions further cause operations comprising:
receiving a playlist, wherein the playlist comprises pre-selected views at which to present the media asset; and
determining a current view for presentation based on the playlist.

21. The non-transitory, computer readable media of claim 13, wherein the instructions further cause operations comprising:
receiving a first user input, wherein the first user input selects a first view at which to present the media asset;
determining a current view at which the media asset is currently being presented;
determining a series of views to transition through when switching from the current view to the first view, wherein the series of views to transition through when switching from the current view to the first view is based on a number of total content streams available for the media asset; and
determining a content stream corresponding to each of the series of views.
